(19) United States
(12) Patent Application Publication
(10) Pub. No.: US 2023/0342825 A1
(43) Pub. Date: Oct. 26, 2023

(54) AIRLINE TICKET MANAGEMENT METHOD AND APPARATUS, COMPUTERREADABLE STORAGE MEDIUM, AND PROGRAM PRODUCT

(71) Applicant: China Eastern Airlines Co., Ltd., Shanghai (CN)

(72) Inventors: Shunxi Xiao, Shanghai (CN); Qian Xiao, Shanghai (CN)

(21) Appl. No.: 17/790,822

(22) PCT Filed: Oct. 28, 2021
(86) PCT No.: PCT/CN2021/126951

§ 371 Date: Jul. 5, 2022

(30) Foreign Application Priority Data
Feb. 5, 2021 (CN) 202110160929.0

(51) Int. Cl. G06Q 30/0283; G06Q 30/0601

(52) U.S. Cl. CPC G06Q 30/0283; G06Q 30/0629

(57) ABSTRACT

This disclosure relates an airline ticket management method and apparatus, a computer-readable storage medium, and a program product. The airline ticket management method comprises: acquiring a distance addition instruction, wherein the distance addition instruction is configured to indicate a first distance and a first user; and adding the first distance into a first distance pool of the first user.

### CROSS-REFERENCE TO RELATED APPLICATIONS

This application claims the priority to the Chinese patent application No. 202110160929.0 filed on Feb. 5, 2021, the entirety of which is hereby incorporated by reference.

### TECHNICAL FIELD

This disclosure relates generally to the technical field of ticket management, and more particularly, to an airline ticket management method, an airline ticket management apparatus, a computer-readable storage medium, and a computer program product.

### BACKGROUND

On the market, airline ticket sales have relied primarily on ticket agents, travel agents, and the like for many years. Since 2015, in order to respond to documentation requirements of the State-owned Assets Supervision and Administration Commission of the State Council, airline companies have launched the “raising direct sales and reducing sales by agents” project to vigorously develop direct sales channels and build information platforms, so that airline companies' own ticket sales capacities are gradually enhanced. In general, compared with the sales by agents, the direct sales have preliminarily changed user consumption habits and improved user reach. However, the current airline ticket sales are still based on actual travel needs of users, that is, airline tickets are managed according to a starting point, an ending point, and a time of a flight, which is disadvantageous in management, and is difficult to leverage or excavate new user needs, resulting in poor user experience.

### SUMMARY

It is one of objectives of the present disclosure to provide an airline ticket management method, an airline ticket management apparatus, a computer-readable storage medium, and a computer program product.

According to an aspect of the present disclosure, there is provided an airline ticket management method, comprising:
acquiring a distance addition instruction, wherein the distance addition instruction is configured to indicate a first distance and a first user; and
adding the first distance into a first distance pool of the first user.

According to another aspect of the present disclosure, there is provided an airline ticket management apparatus, comprising:
a memory having thereon stored instructions; and
a processor configured to execute instructions stored on the memory to perform the airline ticket management method as described above.

According to yet another aspect of the present disclosure, there is provided a computer-readable storage medium, comprising computer-executable instructions which, when executed by one or more processors, cause the one or more processors to perform the airline ticket management method as described above.

According to still another aspect of the present disclosure, there is provided a computer program product, comprising computer instructions which, when executed by one or more processors, implement the steps of the airline ticket management method as described above.

### BRIEF DESCRIPTION OF THE DRAWINGS

The accompanying drawings, which constitute a part of this specification, illustrate embodiments of the present disclosure and, together with the description, serve to explain the principles of the present disclosure.

The present disclosure can be more clearly understood from the following detailed description made with reference to the accompanying drawings, in which:

FIG. 1 shows at least partial flow diagram of an airline ticket management method according to an exemplary embodiment of the present disclosure;

FIGS. 2(a) to 2(c) show interfaces of an APP presented in a process of purchasing a distance by a user in a specific example;

FIGS. 3(a) to 3(e) show interfaces of an APP presented in a process of binding a distance by a user in a specific example;

FIGS. 4(a) to 4(c) show time series distribution plots of passenger revenue per available seat kilometer of already carried passenger tickets at each booking time node in 2017-2019, respectively;

FIGS. 5(a) to 5(c) show time series distribution plots of passenger revenue per available seat kilometer of already carried domestic passenger tickets at each booking time node in 2017-2019, respectively;

FIG. 6 shows a per passenger revenue distribution of domestic route economy classes in 2017-2019;

FIG. 7 shows a per passenger revenue per available seat kilometer distribution of domestic route economic classes in 2017-2019;

FIG. 8 shows a per passenger kilometer distribution of domestic route economy classes in 2017-2019;

FIG. 9 shows a partial flow diagram of an airline ticket management method according to an exemplary embodiment of the present disclosure;

FIGS. 10(a) to 10(c) show interfaces of an APP presented in a process of redeeming a distance by a user in a specific example;

FIG. 11 shows a partial flow diagram of an airline ticket management method according to an exemplary embodiment of the present disclosure;

FIG. 12 shows a schematic diagram of a full time series voluntary refund function;

FIG. 13 shows a partial flow diagram of an airline ticket management method according to an exemplary embodiment of the present disclosure;

FIG. 14 shows a partial flow diagram of an airline ticket management method according to an exemplary embodiment of the present disclosure;

FIG. 15 shows an exemplary configuration of an airline ticket management apparatus that can implement exemplary embodiments according to the present disclosure.

### DETAILED DESCRIPTION

The following detailed description is made with reference to the accompanying drawings and is provided to help full understand various exemplary embodiments of the present disclosure. The following description comprises various details to facilitate understanding, but these details are to be regarded as examples only and are not intended to limit the present disclosure, which is defined by the attached claims and their equivalents. Words and phrases used in the following description are intended only to provide a clear and consistent understanding of the present disclosure. In addition, the description of well-known structures, functions, and configurations may be omitted for clarity and conciseness. Those of ordinary skill in the art will recognize that various changes and modifications of the examples described herein can be made without departing from the spirit and scope of the present disclosure.

In the present disclosure, there is provided a distance-based airline ticket management method to help a user to purchase a distance, redeem an airline ticket by using the distance or perform operations such as refunding and rescheduling based on the distance, thereby helping to arouse new needs of the user and improve user experience, and thereby increasing revenues of enterprises or organizations such as airline companies and the like, and improving their business management.

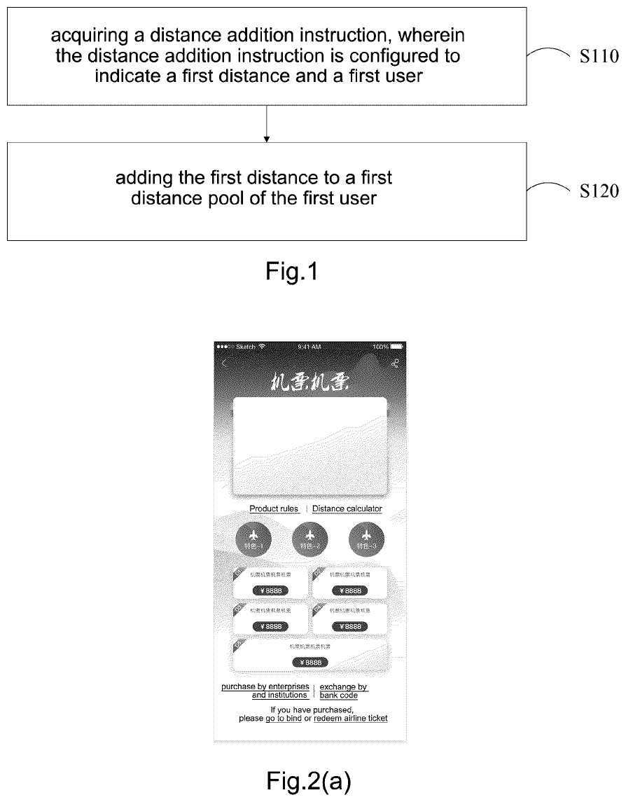

As shown in FIG. 1, in an exemplary embodiment of the present disclosure, an airline ticket management method can comprise:
step S110, acquiring a distance addition instruction, wherein the distance addition instruction is configured to indicate a first distance and a first user; and
step S120, adding the first distance to a first distance pool of the first user.

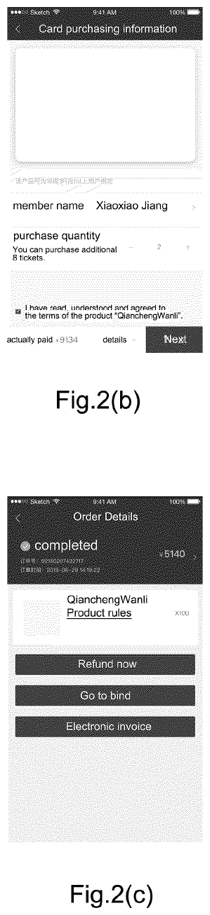

Specifically, the distance addition instruction can be used for adding a certain number of distances into a distance pool of a certain user for the user to redeem an airline ticket when needed. The user described herein can be an individual user or an institutional user. Typically, the distance in the distance pool of the individual user is for the use of the user only or for the use of the user and a small number of persons having a certain relationship with the user, while the distance in the distance pool of the institutional user can be for the use of a plurality of persons belonging to the institution. Before the distance addition instruction is generated, the user can purchase the distance through an application (APP) installed in a mobile terminal (e.g., a smart phone, a tablet computer, etc.) or a web edition client, etc. in a specific example, FIGS. 2 (a) to 2 (c) show interfaces of an APP that can be presented in a process of purchasing the distance by the user, and by clicking a corresponding area on the interface of FIG. 2 (a), the user can know relevant information such as “product rules” and select an appropriate distance to be purchased. In the interface shown in FIG. 2 (b), the user can fill in relevant information. The interface shown in FIG. 2(c) is a relevant information page after the purchase is successful, to help the user to learn the situation of the distance purchase. In addition, the user can, on this interface, continue to perform operations such as refunding, binding of the distance and invoicing.

After the distance is purchased, at least a part of the purchased distance can be added into the corresponding distance pool by the distance addition instruction, that is, the part of the distance is bound to a specific user. It is to be noted that the user who purchases the distance and the user who is bound with the purchased distance can be the same user or different users. For example, a first user can purchase distances by himself/herself, and a distance addition instruction from the first user can add these distances into a first distance pool of the first user. Alternatively, distances can be purchased by a second user, and a distance addition instruction from the second user can add these distances into the first distance pool of the first user. In some other embodiments, the distance addition instruction can also come from an airline company, for example, the airline company can, through the distance addition instruction, add distances provided (e.g., rewarded) to certain users who meet preset conditions into distance pools of these users, respectively.

The first distance indicated by the distance addition instruction is the distance to be added, and the indicated first user is the user to be bound with the first distance. In a process of adding the first distance to the first distance pool of the first user, it can be first queried in a relevant database whether the first distance pool of the first user exists. When the first distance pool of the first user already exists, the first distance can be directly added into the first distance pool; and when the first distance pool of the first user does not exist, it is indicated that the first user may be a new user, and the first distance pool thereof can be first created for the first user and then the first distance is added into the first distance pool.

In some embodiments, the first distance can be an integer multiple of a minimum added distance. For example, a minimum added distance can be 10000 kilometers, and the first distance can be 10000 kilometers, 20000 kilometers, and so on. It can be understood that when the distance is purchased by the user, the minimum added distance can also be taken as a minimum unit accordingly.

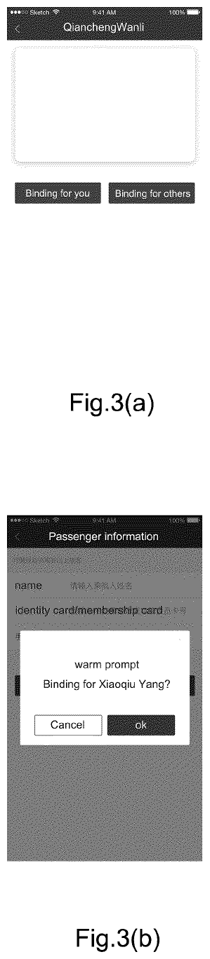

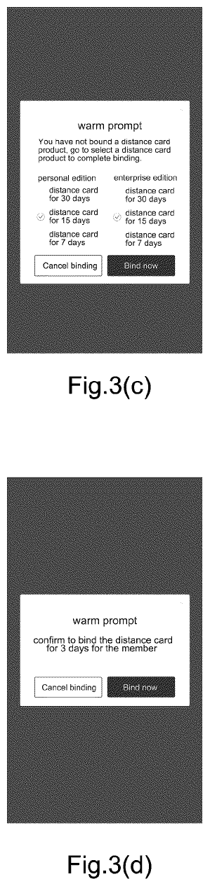

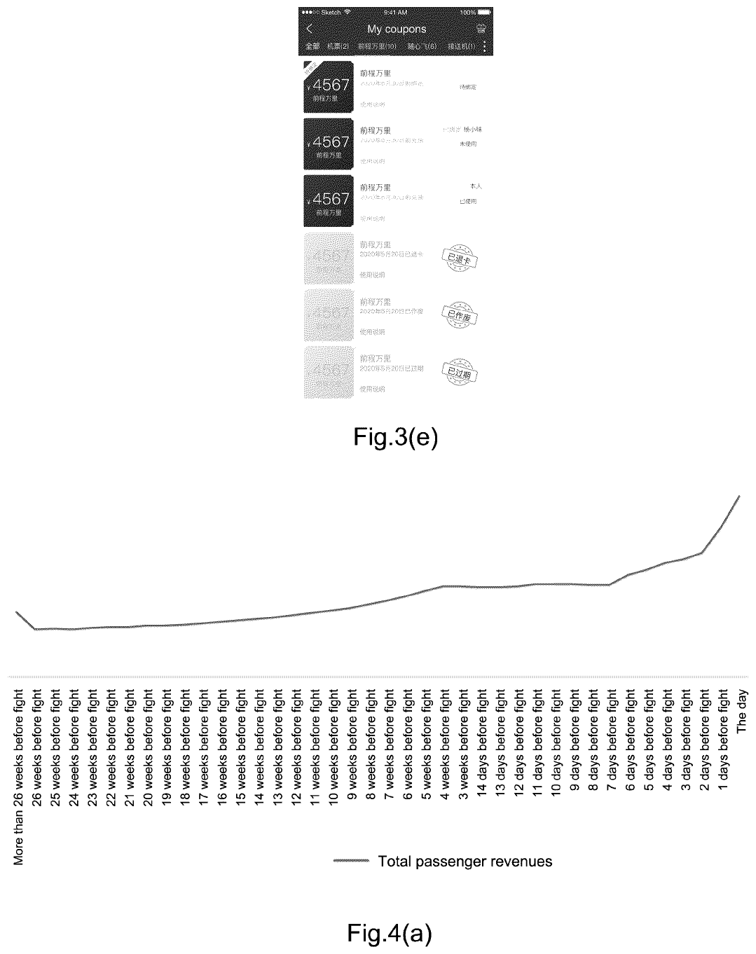

FIGS. 3(a) to 3(e) show interfaces of an APP that can be presented when binding a distance by a user. Corresponding to a case of “bound for others” in FIG. 3 (a), the user can confirm, in the interface shown in FIG. 3 (b), information of the user bound with the distance. Furthermore, the user can select a specific distance to be bound in the interface shown in FIG. 3 (c). Alternatively, corresponding to a case of “bound for you”, the user can confirm binding information in the interface as shown in FIG. 3 (d). After the binding is completed, the user can learn relevant information in the interface shown in FIG. 3 (e).

The minimum added distance can be determined based on a variety of factors such that the minimum added distance is not wasted due to excessive idleness while being capable of meeting travel needs of most users. In some embodiments, the minimum added distance can be determined according to historical distances of a plurality of users within a first time range.

For example, according to relevant data analysis of a China Eastern Airlines' historical product, it is reasonable to set 10000 kilometers as a minimum added distance corresponding to an individual, because it can already meet travel needs of most users. In addition, for an institutional user, a corresponding minimum added distance can be determined according to parameters such as scale of the institution, and generally, the minimum added distance of the institutional user is greater than that of the individual user. Of course, in other embodiments, the minimum added distance can be determined in conjunction with other factors, which are not limited here.

In some embodiments, a price of the minimum added distance can also be determined according to the minimum added distance and at least one of: (1) a first distribution of total airline ticket revenues with respect to the number of users within a second time range; (2) a second distribution of airline ticket revenues per unit distance with respect to the number of users within a third time range; and (3) a flight time range of an airline ticket for which the minimum added distance is redeemable.

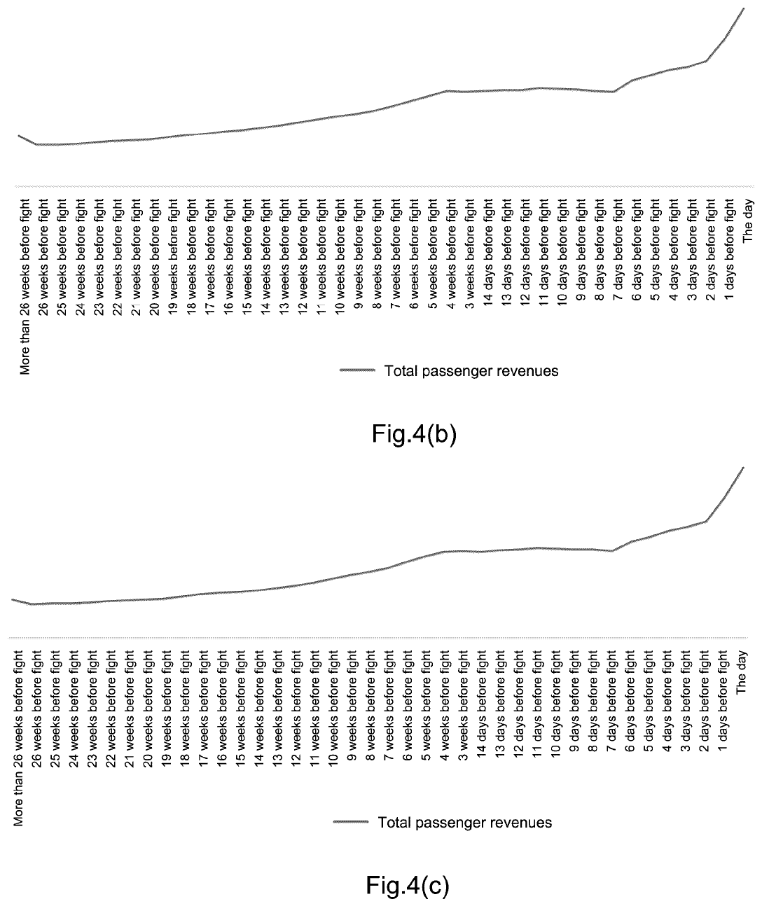

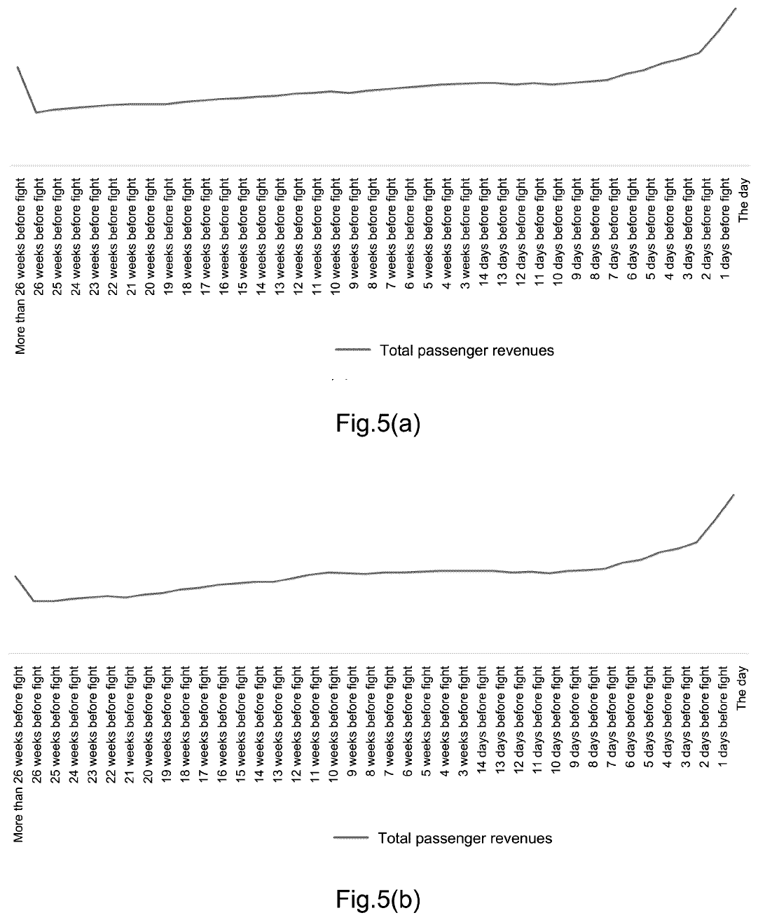

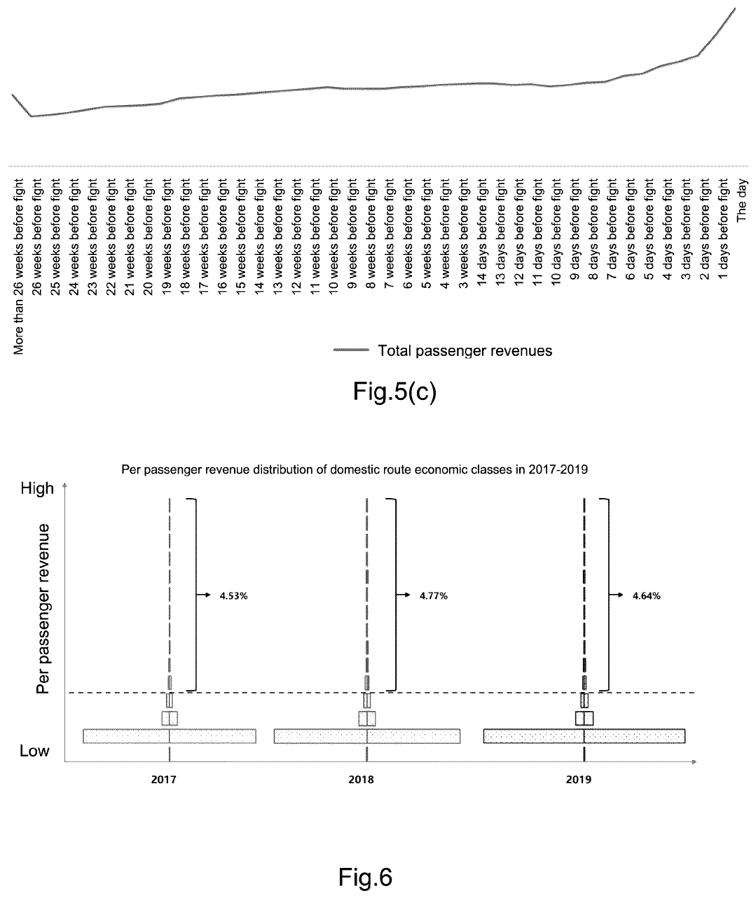

The flight time range of the airline ticket for which the minimum added distance is redeemable is determined at least according to differences between historical booking times and flight times of a plurality of airline tickets within a fourth time range. In a specific example, FIGS. 4(a) to 4(c) show time series distribution plots of passenger revenue per available seat kilometer of already carried passenger tickets at each booking time node in 2017-2019, respectively, and FIGS. 5(a) to 5(c) show time series distribution plots of passenger revenue per available seat kilometer of already carried domestic passenger tickets at each booking time node in 2017-2019, respectively. It can be seen from FIGS. 4(a) to 5(c) that, within a fourth time range of the three years of 2017-2019, there are airline ticket booking peaks substantially about 30 days, 14 days, 7 days and 3 days before a flight, and therefore, the flight time range of the airline ticket for which the minimum added distance is redeemable can be set 30 days, 14 days, 7 days and 3 days before a flight, to facilitate the user to select a required distance according to his/her own needs. In addition, an all-purpose minimum added distance before a flight can also be set, and a latest time before the flight can correspond to 4 hours before takeoff, so an all-purpose distance before the flight can be redeemed 4 hours before the flight takes off at the latest. Of course, in other embodiments, the flight time range that is redeemable can also be determined according to other factors, which are not limited here.

It can be appreciated that as the flight time range of the airline ticket for which the minimum added distance is redeemable increases, flexibility of the distance redemption is higher and the price of the corresponding distance can also be higher. For example, for a same minimum added distance of 10000 kilometers, a price of a minimum added distance of 30 days before a flight can be generally lower than that of an all-purpose minimum added distance before the flight.

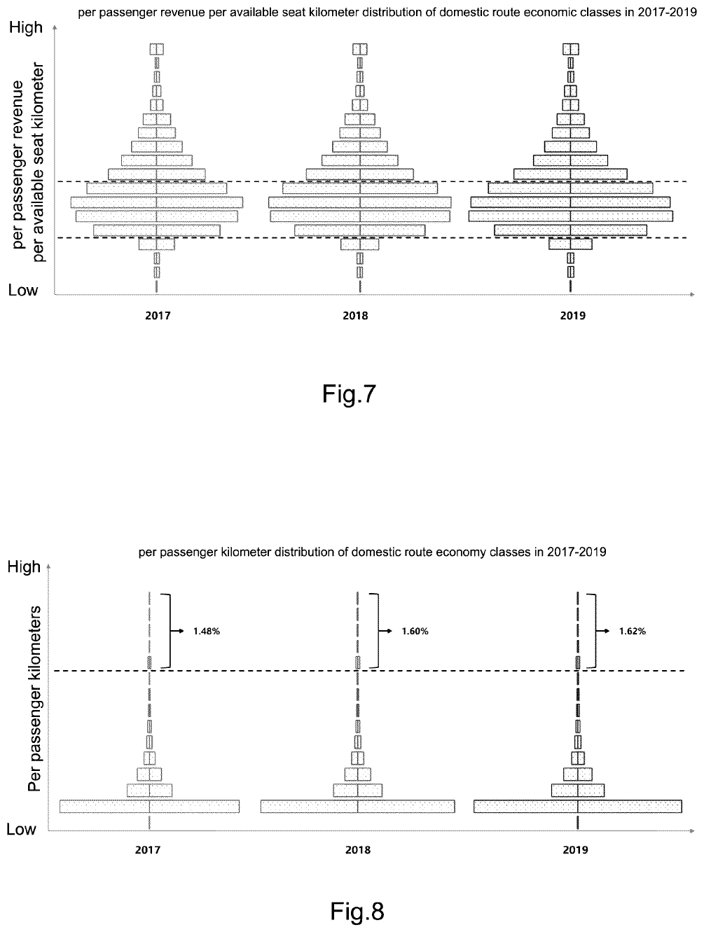

Furthermore, when the price of the minimum added distance is determined, at least one of the first distribution of the total airline ticket revenues with respect to the number of users within the second time range and the second distribution of the airline ticket revenues per unit distance with respect to the number of users within the third time range can also be processed based on a process such as big data processing or machine learning, to determine the price. FIG. 6 shows a per passenger revenue distribution of domestic route economic classes in 2017-2019, wherein an abscissa represents the number of people and an ordinate represents total airline revenues of the domestic route economic classes that correspond to each user, i.e., per passenger revenues. It can be seen that the number of people having higher per passenger revenue accounts for only a small part of the total number, while most users have lower per passenger revenue. FIG. 7 shows a per passenger revenue per available seat kilometer distribution of domestic route economy classes in 2017-2019, wherein an abscissa represents the number of people and an ordinate represents revenue per available seat kilometer of the domestic route economy classes that correspond to each user, i.e., per passenger revenue per available seat kilometer. It can be seen that the number of people having higher per revenue per available seat kilometer is also less, and per revenue per available seat kilometer of most users are lower. FIG. 8 is a per passenger kilometer distribution of domestic route economic classes in 2017-2019, wherein an abscissa represents the number of people and an ordinate represents kilometers per person, i.e., per passenger kilometers. It can be seen that the number of people having higher per passenger kilometers also accounts for only a small part, while most users have lower per passenger kilometers. In a pricing process, reference can be made to the per passenger revenue distribution and the per passenger revenue per available seat kilometer distribution. For example, in a specific example, when a cumulative proportion of the number of people accumulated according to the per passenger revenues from low to high is closest to 50%, a product of a distance unit price corresponding to the per passenger revenues at that time and the minimum added distance is determined as a price of the minimum added distance. Alternatively, when a cumulative proportion of the number of people accumulated according to the per passenger revenue per available seat kilometer from low to high is closest to 50%, a product of a distance unit price corresponding to the per passenger revenue per available seat kilometer at that time and the minimum added distance is determined as a price of the minimum added distance.

In addition, in order to adapt to the needs of different users, the users can be graded, and for the different graded users, corresponding prices, refund rules, rescheduling rules, etc. can be formulated, respectively. It can be appreciated that for a user traveling more and more frequently, a more favorable price, refund rule, rescheduling rule, etc. can be employed. For example, in the case of equal purchases, prices for different graded users can be in an arithmetic progression.

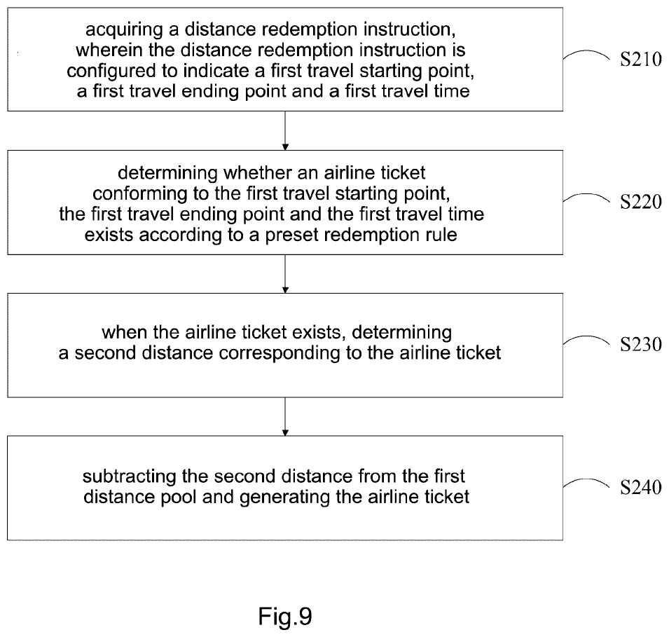

As shown in FIG. 9, in an exemplary embodiment of the present disclosure, the airline ticket management method can further comprise:
step S210, acquiring a distance redemption instruction, wherein the distance redemption instruction is configured to indicate a first travel starting point, a first travel ending point and a first travel time;
step S220, determining whether a redeemable airline ticket conforming to the first travel starting point, the first travel ending point and the first travel time exists according to a preset redemption rule;
step S230, when the airline ticket exists, determining a second distance corresponding to the airline ticket; and
S240, subtracting the second distance from a first distance pool and generating the airline ticket.

The distance redemption instruction can be given by the first user and indicates at least the first travel starting point, the first travel ending point, and the first travel time. In some embodiments, the first user, before the distance redemption instruction is given, can query airline tickets meeting his/her own travel needs through a ticket querying system or the like, and select such one or more airline tickets so that corresponding information of the first travel starting point, the first travel ending point, and the first travel time is comprised in the distance redemption instruction. In some other embodiments, the first user can also directly give the distance redemption instruction indicating the first travel starting point, the first travel ending point, and the first travel time, and determine the corresponding airline ticket in a subsequent step. The first travel time can specifically comprise a departure time, an arrival time, a travel duration, or the like.

In some embodiments, the distance in the first distance pool of the first user can be used for redeeming an airline ticket for the first user himself. At this time, the distance redemption instruction may not indicate the first user.

In practice, however, on the one hand, the first user may travel together with a child aged, for example, between 2 and 16, and purchasing an airline ticket separately for such a child may be relatively difficult; and on the other hand, the first user may also have a need for redeeming an airline ticket for a different third user by using his/her own distance. To meet the above needs, the distance in the first distance pool can also be configured to be redeemable for an airline ticket for the third user. In this case, the distance redemption instruction can also be configured to indicate the third user, to provide relevant information about the third user. Of course, in order to avoid decrease in airline company profits caused by too many users sharing one same distance pool, the distance in the first distance pool can be configured to be used for redeeming airline tickets for two different users at most, or certain limitations can be imposed on the third user, for example, a third user is limited only to a child aged between 2 and 16, and the like. In some cases, the third user can also be replaced when the number of users sharing the same distance pool is constant.

After the distance redemption instruction is acquired, it can be determined whether a redeemable airline ticket conforming to the first travel starting point, the first travel ending point and the first travel time exists according to the preset redemption rule. The preset redemption rule can relate to factors such as a flight time range of an airline ticket for which the distance in the first distance pool is redeemable, a validity period of the distance and so on.

In some embodiments, the determining whether the redeemable airline ticket conforming to the first travel starting point, the first travel ending point, and the first travel time exists according to the preset redemption rule can comprise:
determining whether or not the first travel time falls within a flight time range of an airline ticket for which at least part of the distance in the first distance pool is redeemable;

if so, determining whether the airline ticket conforming to the first travel starting point, the first travel ending point and the first travel time exists; and
if not, generating first redemption failure information.

That is to say, if there is a candidate airline ticket before the distance redemption instruction is generated, the redemption can further performed when the distance that is redeemable for the airline ticket with the corresponding flight time range exists in the first distance pool. Alternatively, it can also be determined first that the distance that is redeemable for the airline ticket with the corresponding flight time range exists in the first distance pool, and then a specific airline ticket is determined. Otherwise, the first redemption failure information will be generated to prompt the first user that there is no distance in the current first distance pool that is redeemable for the corresponding airline ticket, so that the redemption cannot be continued.

In some embodiments, the determining whether the redeemable airline ticket conforming to the first travel starting point, the first travel ending point, and the first travel time exists according to the preset redemption rule can comprise:
determining whether a current redemption time is within a validity period of at least part of the distance in the first distance pool or not;
if so, the first travel ending point and the first travel time exists; and
if not, generating second redemption failure information.

The validity period of the distance refers to a redemption time range within which the distance can be used for redeeming the airline ticket. For example, the validity period of the distance can be one year since it has been bound with the first user. Then, the distance can be used for redeeming the airline ticket within one year after the binding. And if the distance has not been bound with the first user or the distance have been bound with the first user for more than one year, the distance is not within the validity period and cannot be used for redeeming the airline ticket.

That is to say, if there is a candidate airline ticket before the distance redemption instruction is generated, the redemption can be further performed when the distance within the validity period exists in the first distance pool. Alternatively, it can be determined first that the distance within the validity period exists in the first distance pool, and then a specific airline ticket to be redeemed is determined. Otherwise, the second redemption failure information can be generated to prompt the user that there is no distance in the current first distance pool that is within the validity period, so that the redemption cannot be continued.

In order to avoid that the first distance added into the first distance pool is invalid because it has not been redeemed for a long time, which brings great economic loss to the user, in some embodiments, the airline ticket management method can further comprise:
subtracting the first distance from the first distance pool and refunding a fare corresponding to the first distance when the first distance has not been redeemed within a fifth time range after being added into the first distance pool.

In a specific example, when the first distance has not yet been redeemed seven days after being added into the first distance pool or three months after being added into the first distance pool, it can be refunded automatically, and the fare corresponding to the first distance can be refunded on the same way.

It can be understood that the fifth time range can also be another time range. In some embodiments, the fifth time range can be determined at least according to a first validity period of the first distance. In other embodiments, the fifth time range can also be determined according to other factors.

In some embodiments, considering that a variety of distances with different validity periods can be comprised in the first distance pool of the first user, in order to fully utilize these distances, the subtracting the second distance from the first distance pool can comprise:
preferentially subtracting a distance with a validity period expired earlier from the first distance pool.

In some other embodiments, after a new distance is added into the distance pool by the user, a validity period of at least a part of existing distances in the distance pool can be prolonged according to a validity period of the newly added distance. Specifically, the airline ticket management method can further comprise:
determining whether an expiration time of a validity period of an existing distance in the first distance pool is earlier than a first expiration time of a first validity period of the first distance after the first distance is added into the first distance pool of the first user.

If the expiration time of the validity period of the existing distance is earlier than the first expiration time, it is determined whether the first expiration time is later than a preset longest expiration time.

The preset longest expiration time can be determined according to a binding time when the distance is added into the first distance pool plus a preset time threshold. In a specific example, the preset time threshold can be three years, that is to say, the preset longest expiration time is three years after the binding time. In this case, the validity period of the distance in the distance pool can only be prolonged up to three years from the binding time.

Further, if the first expiration time is later than the preset longest expiration time, the expiration time of the validity period of the existing distance is prolonged to the preset longest expiration time; and if the first expiration time is not later than the preset longest expiration time, the expiration time of the validity period of the existing distance is prolonged to be consistent with the first expiration time. In this way, the validity period of the existing distance can be prolonged in a reasonable range, so that the validity period of the distance can be more flexible, and meanwhile infinitely prolonging the validity period of the existing distance by continuously adding the new distance into the first distance pool is avoided, and therefore, benefits of the user and the airline are compromised.

Furthermore, for an existing distance in the first distance pool that has an expiration time later than the first expiration time, their expiration time can be retained so as not to bring loss to the user.

After it is determined that there is the airline ticket complying with the preset redemption rule and the distance redemption instruction, it is necessary to determine the second distance corresponding to the airline ticket to subtract the second distance from the first distance pool of the first user for the redemption. In some embodiments, the determining the second distance corresponding to the airline ticket can comprise:
determining a first travel distance between the first travel starting point and the first travel ending point as the second distance.

That is to say, the travel distance between the travel starting point and the travel ending point can be directly taken as the second distance. For example, when a first travel starting point is Beijing and a first travel ending point is Shanghai, the second distance is determined as 1088 kilometers since the first travel distance between Beijing and Shanghai is 1088 kilometers.

Ina further embodiment of the present disclosure, considering that users may have different needs for cabins, in order to facilitate management of cabin selections based on the distance, the distance redemption instruction can also be configured to indicate cabin information. Accordingly, the determining the second distance corresponding to the airline ticket can comprise:
determining the first travel distance between the first travel starting point and the first travel ending point;
determining a cabin coefficient according to the cabin information; and
determining a product of the first travel distance and the cabin coefficient as the second distance.

Through the cabin coefficient, different cabin levels can be reflected with the distance, so that the airline ticket management is facilitated. For example, a cabin coefficient of an economy class can be set to 1, a cabin coefficient of a business class can be set to 2, and a cabin coefficient of a first class can be set to 4. Then, in the process of redeeming the airline ticket, if the first travel starting point is Beijing and the first travel ending point is Shanghai, the first travel distance can be determined as 1088 kilometers, and then, in combination with the cabin coefficients corresponding to the different cabins, it can be concluded that the second distance required for redeeming the economy class is 1088 kilometers, the second distance required for redeeming the business class is 2176 kilometers, and the second distance required for redeeming the first class is 4352 kilometers.

It can be understood that, in some other embodiments, a corresponding coefficient can be set and the second distance for redeeming the airline ticket can be adjusted according to a flight time, popularity of a route, and the like, so as to realize, for example, distance redemption discounts, and therefore, the airline ticket can be flexibly managed based on the distance.

In some embodiments of the present disclosure, the distance redemption instruction can also indicate other fee information, such as fuel fee, infrastructure fee, baggage consignment fee, insurance fee, and possible shopping fee, and the like. In this way, the determining the second distance corresponding to the airline ticket can comprise:
determining the first travel distance between the first travel starting point and the first travel ending point;
determining an eighth distance corresponding to other fee information; and
determining a sum of the first travel distance and the eighth distance as the second distance.

By converting other various fees into the eighth distance and adding the eighth distance into the second distance, the user can pay the whole fees by using the distance in the distance pool without the need of paying by cash, bank card and the like additionally, which greatly facilitates the travel of the user and improves the user experience.

In some embodiments, considering that a remaining distance in the first distance pool may be insufficient to redeem a certain airline ticket, in order to process this scenario, the determining the second distance corresponding to the airline ticket can comprise:
determining a third distance according to the distance redemption instruction;
determining whether the third distance is greater than the remaining distance in the first distance pool or not;
if so, taking the remaining distance as the second distance, and generating price difference information according to a difference between the third distance and the remaining distance; and
if not, taking the third distance as the second distance.

That is to say, in the process of determining the second distance, it can also be verified whether the remaining distance in the first distance pool is sufficient for the redemption. The third distance is a distance that maybe redeemed and directly corresponds to the distance redemption instruction, that is, the third distance can be determined according to the information such as the first travel starting point, the first travel ending point, and the cabin coefficient with reference to the above mentioned embodiment. Then, the third distance and the remaining distance is compared, if the third distance is greater than the remaining distance, it is indicated that the distance in the first distance pool is insufficient, and the remaining distance can be taken as the second distance to be subtracted; in addition, for an insufficient distance part, a price difference thereof can be calculated to generate the price difference information to wait for the user to make up the price difference. Specifically, the price difference needing to be made up can be determined according to a product of the distance difference between the third distance and the remaining distance and a unit price corresponding to the minimum added distance . In addition, if the third distance is less than or equal to the remaining distance, it is indicated that the distance in the first distance pool is sufficient, and at this time, the third distance is directly taken as the second distance to be subtracted from the first distance pool.

It can be appreciated that the subtracting the second distance from the first distance pool and generating the airline ticket can further comprise:
determining whether a fare corresponding to the price difference information is acquired or not;
if so, subtracting the second distance from the first distance pool, and generating the airline ticket; and
if not, generating third redemption failure information.

That is to say, when the user needs to make up the price difference, it can be verified whether the price difference has been made up, redeeming the airline ticket is continued on the premise that the price difference has been made up, otherwise, the third redemption failure information is generated to prompt the user to make up the price difference.

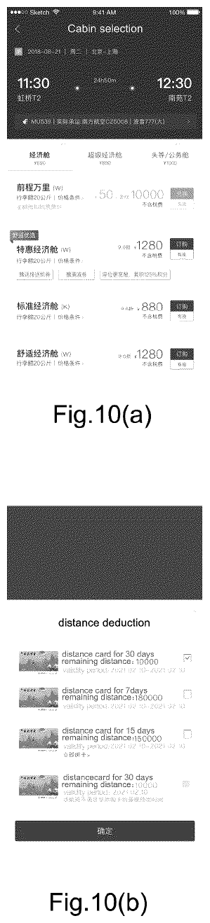

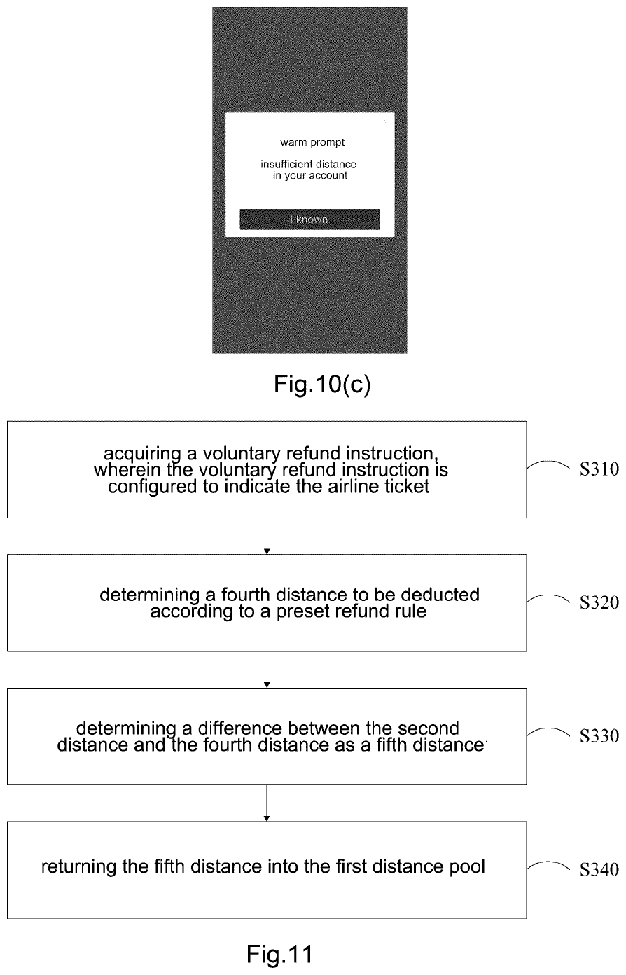

FIGS. 10 (a) to 10 (c) show interfaces of an APP that may appear when a distance is redeemed in a specific example. The user can select a flight to be redeemed in the interface shown in FIG. 10 (a) and select the distance for redeeming the corresponding flight in the interface shown in FIG. 10 (b). Furthermore, when the distance for the redemption is insufficient, the interface shown in FIG. 10(c) can be displayed by the APP to prompt the user.

In practice, the travel of the user may change, or some flights may change due to reasons such as air route, which involves refund and rescheduling of the airline ticket. It can be defined herein that the refund and rescheduling initiated by the user is voluntary refund and voluntary rescheduling, respectively, and that refund due to other reasons is compulsory refund.

In the case of the voluntary refund, the user is typically required to pay a refund fee. In conventional airline ticket management, the refund fee can be determined according to the cabins. However, in the airline ticket management method of the present disclosure, since management is performed based on the distance, processing directly related to the cabins may not be set. Therefore, in the present disclosure, there is also provided a new refund rule to solve the above problem. In an exemplary embodiment of the present disclosure, as shown in FIG. 11, the airline ticket management method can further comprise:
step S310, acquiring a voluntary refund instruction, wherein the voluntary refund instruction is configured to indicate the airline ticket;
step S320, determining a fourth distance to be deducted according to a preset refund rule;
step S330, determining a difference between the second distance and the fourth distance as a fifth distance; and
step S340, returning the fifth distance into the first distance pool.

Specifically, the airline ticket indicated by the voluntary refund instruction is an airline ticket to be refunded. The fourth distance to be deducted can be calculated according to the preset refund rule, and then only the difference between the second distance and the fourth distance, namely the fifth distance, is returned into the first distance pool, and the fourth distance is deducted as the refund fee, so as to simplify the refund process.

There can be a variety of preset refund rules. In some embodiments, the determining the fourth distance to be deducted according to the preset refund rule can comprise:
determining the fourth distance according to a refund initiation time and the flight time of the airline ticket.

As a difference between the flight time and the refund initiation time decreases, loss that the airline company may suffer can be greater, and therefore, the fourth distance can be unchanged or increased.

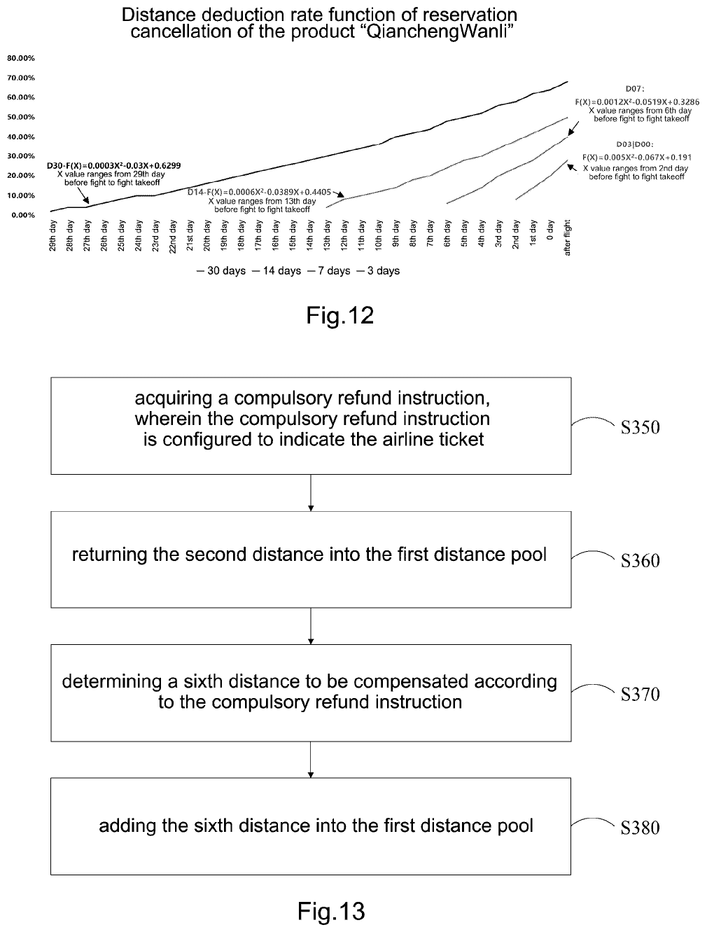

In some embodiments, the fourth distance is a function of the difference between the flight time and the refund initiation time. The function can be determined by fitting relations between refund fees of a plurality of users within a sixth time range with respect to differences between flight times and refund initiation times of airline tickets using at least one of a linear function, a polynomial function, an exponential function, a logarithmic function and a power function. In a specific example, FIG. 12 shows a schematic diagram of a full time series voluntary refund function, wherein an independent variable x of the function is the difference between the flight time and the refund initiation time, and a dependent variable f(x) is the deducted fourth distance. The refund function shown in FIG. 12 is shown in the following table:

| Flight time range for | | |
|---|---|---|
| which the distance | | value range |
| is redeemable | f(x) | of x |
| 30 days before the | f(x) = 0 | x ∈ [30, ∞) |
| flight | f(x) = 0.0003x²-0.03x + 0.6299 | x ∈ [−1, 30) |
| 14 days before the | f(x) = 0 | x ∈ [14, ∞) |
| flight | f(x) = 0.0006x²-0.0389x + 0.4405 | x ∈ [−1, 14) |
| 7 days before the | f(x) = 0 | x ∈ [7, ∞) |
| flight | f(x) = 0.0012x²-0.0519x + 0.3286 | x ∈ [−1, 7) |
| 3 days before the | f(x) = 0 | x ∈ [3, ∞) |
| flight | f(x) = 0.005x²-0.067x + 0.191 | x ∈ [−1, 3) |
| all-purpose before | f(x) = 0 | x ∈ [3, ∞) |
| the flight | f(x) = 0.005x²-0.067x + 0.191 | x ∈ [−1, 3) |

It should be noted that the time later than 4 hours before a flight takes off will be considered to be after the flight, and at this time, x is −1.

In some embodiments, the determining the fourth distance to be deducted according to the preset refund rule can comprise:
determining the fourth distance according to a refund initiation time and a redemption time of the airline ticket,
wherein as a difference between the refund initiation time and the redemption time increases, loss of the airline company may be greater, and accordingly, the fourth distance can be unchanged or increased.

Of course, in some other embodiments, the deducted fourth distance can also be determined jointly in combination with the refund initiation time, the redemption time and the flight time.

As shown in FIG. 13, in an exemplary embodiment of the present disclosure, the airline ticket management method can further comprise:
step S350, acquiring a compulsory refund instruction, wherein the compulsory refund instruction is configured to indicate the airline ticket; and
S360, returning the second distance into the first distance pool.

In the case of the compulsory refund, the distance can no longer be deducted, so as to minimize the loss of the user.

As shown in FIG. 13, the airline ticket management method can further comprise:
step S370, determining a sixth distance to be compensated according to the compulsory refund instruction; and
step S380, adding the sixth distance into the first distance pool.

That is to say, in the case of the compulsory refund, the user can also be given a certain distance compensation. The sixth distance to be compensated can be determined according to the compulsory refund time, and the like, and as the compulsory refund time is closer to or even passes the flight time, the sixth distance to be compensated can be more.

In addition, considering that a second validity period of the returned second distance may be delayed after the compulsory refund, adverse effects will be brought to the user. Therefore, after the second distance is returned into the first distance pool, the airline ticket management method can further comprise: prolonging the second validity period of the second distance.

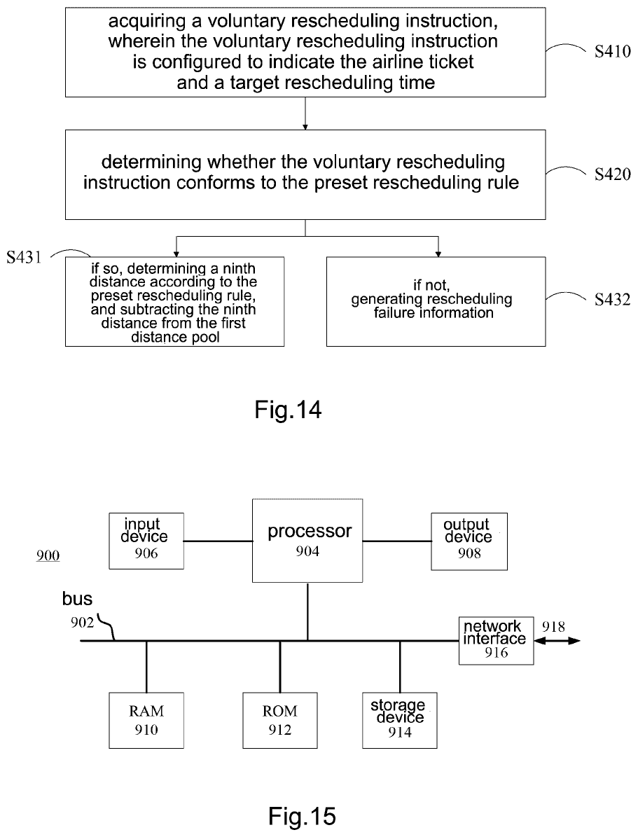

In some embodiments, in order to facilitate the user to avoid multiple operations of refunding and re-purchasing the ticket, when the travel of the user changes, a rescheduling operation can be directly performed, and the distance required to be deducted is determined according to a preset rescheduling rule to serve as a rescheduling fee. As shown in FIG. 14, the airline ticket management method can further comprise:
step S410, acquiring a voluntary rescheduling instruction, wherein the voluntary rescheduling instruction is configured to indicate the airline ticket and a target rescheduling time;
step S420, determining whether the voluntary rescheduling instruction conforms to the preset rescheduling rule or not;
step S431, if so, determining a ninth distance according to the preset rescheduling rule, and subtracting the ninth distance from the first distance pool; and
step S432, if not, generating rescheduling failure information.

Specifically, the airline ticket indicated by the voluntary rescheduling instruction is an airline ticket to be rescheduled, and the indicated target rescheduling time is an expected departure time of the rescheduled airline ticket. The determining whether the voluntary rescheduling instruction conforms to the preset rescheduling rule can specifically comprise determining whether the target rescheduling time is within a time range of an airline ticket for which a corresponding distance is redeemable. For example, when a distance can be used for redeeming an airline ticket after 30 days, if it is expected that the airline ticket is rescheduled to 45 days from now, the preset rescheduling rule is met and the rescheduling can be performed; if it is expected that the airline ticket is rescheduled to a 15th day from now, the preset rescheduling rule is not met and the rescheduling cannot be performed. In addition, in some embodiments, there can be limitations on the number of the rescheduling times and the like, and the limitations can be expressed in the form of the preset rescheduling rule, so as to avoid the loss of the airline company caused by abnormal rescheduling.

When the voluntary rescheduling instruction conforms to the preset rescheduling rule, a ninth distance to be subtracted from the first distance pool can be calculated according to the preset rescheduling rule, and the ninth distance can be deducted as at least one of a rescheduling fee or an airline ticket price difference, so as to simplify the rescheduling procedure.

For example, when a time when rescheduling is proposed by the user before an original flight time is less than one preset time range (e.g., 30 days), the user can be charged for a rescheduling fee. According to the preset rescheduling rule, the ninth distance corresponding to the rescheduling fee can be calculated, and the ninth distance is subtracted from the first distance pool to serve as the rescheduling fee paid by the user. In some embodiments, the ninth distance or rescheduling fee can also be zero. For example, when a time when rescheduling is proposed by the user before an original flight time is greater than or equal to a preset time range (e.g., 30 days), a ninth distance or rescheduling fee can be zero.

For another example, when a new flight time rescheduled is less than one preset time range (e.g., 30 days) before a time when rescheduling is proposed by a user, the user can be charged for an airline ticket price difference. According to the preset rescheduling rule, the ninth distance corresponding to the airline ticket price difference can be calculated, and the ninth distance is subtracted from the first distance pool to serve as the airline ticket price difference paid by the user. In some embodiments, the ninth distance or the airline ticket price difference can also be zero. For example, when a new flight time is greater than or equal to a preset time range (e.g., 30 days) before a time when rescheduling is proposed by a user, a ninth distance or airline ticket price difference can be zero.

It can be understood that, in some embodiments, the ninth distance can also comprise both the rescheduling fee and the airline ticket price difference, for example, when a time when rescheduling is proposed by a user before an original flight time is less than one preset time range, and a new flight time rescheduled before the time when rescheduling is proposed by the user is less than one preset time range, the rescheduling fee and the airline ticket price difference need to be calculated respectively, and a corresponding ninth distance is deducted from the first distance pool.

When the voluntary rescheduling instruction does not conform to the preset rescheduling rule, rescheduling failure information can be generated to prompt the user of the rescheduling failure or provide the user with a reason for the rescheduling failure and the like.

In some embodiments of the present disclosure, there may be a case where a distance has been purchased by a certain user but has not been bound with himself or another user. In order to guarantee the benefits of the user, the airline ticket management method can further comprise:
when there is a seventh distance that has still not been redeemed into a distance pool of any user within a seventh preset time range after being purchased, returning a fare corresponding to the seventh distance.

In the present disclosure, there is further provided an airline ticket management apparatus, and FIG. 15 shows an exemplary configuration capable of implementing an airline ticket management apparatus 900 according to an exemplary embodiment of the present disclosure.

The airline ticket management apparatus 900 is an example of a hardware device to which the present disclosure can be applied. The airline ticket management apparatus 900 can be any machine configured to perform at least one of processing and computing. The airline ticket management apparatus 900 can be, but is not limited to, a workstation, a server, a desktop computer, a laptop computer, a tablet computer, a personal data assistant (PDA), a smart phone, an on-board computer, or a combination of the above.

As shown in FIG. 15, the airline ticket management apparatus 900 can comprise one or more elements that can be connected with or communicate with a bus 902 via one or more interfaces. The bus 902 can comprise, but is not limited to, an industry standard architecture (ISA) bus, a micro channel architecture (MCA) bus, an enhanced ISA (EISA) bus, a video electronics standards association (VESA) local bus, and a peripheral component interconnect (PCI) bus and the like.

The airline ticket management apparatus 900 can comprise, for example, one or more processors 904, one or more input devices 906, and one or more output devices 908. The one or more processors 904 can be any kind of processor and can comprise, but are not limited to, one or more general-purpose processors or special-purpose processors (such as special-purpose processing chips). The processor 902 can be configured to implement the airline ticket management method, for example. The input device 906 can be any type of input device capable of inputting information to the airline ticket management apparatus 900 and can comprise, but is not limited to, at least one of a mouse, a keyboard, a touch screen, a microphone and a remote controller. The output device 908 can be any type of device capable of presenting information and can comprise, but is not limited to, at least one of a display, a speaker, a video/audio output terminal, a vibrator and a printer.

The airline ticket management apparatus 900 can further comprise or be connected to a non-transitory storage device 914, which can be any storage device that is non-transitory and can implement data storage, and can comprise, but is not limited to, at least one of a disk drive, an optical storage device, a solid-state memory, a floppy disk, a flexible disk, a hard disk, a tape or any other magnetic medium, a compact disk or any other optical medium, a cache memory or any other memory chip or module, and any other medium from which a computer can read data, instructions, or code. The airline ticket management apparatus 900 can also comprise a random access memory (RAM) 910 and a read-only memory (ROM) 912. The ROM 912 can store programs, utilities or processes to be executed in a nonvolatile manner. The RAM 910 can provide volatile data storage and store instructions related to the operation of the airline ticket management apparatus 900. The airline ticket management apparatus 900 can also comprise a network/bus interface 916 coupled to a data link 918. The network/bus interface 916 can be any kind of device or system capable of enabling communication with at least one of an external apparatus and a network, and can comprise, but is not limited to, at least one of a modem, a network card, an infrared communication device, a wireless communication device and a chipset (such as a Bluetooth™ device, an 802.11 device, a WiFi device, a WiMax device, a cellular communication facility, etc.).

In the present disclosure, there is also provided a computer-readable storage medium comprising computer-executable instructions which, when executed by one or more processors, cause the one or more processors to perform the airline ticket management method as described above. The present disclosure can be implemented as any combination of the apparatus, system, integrated circuit, and computer program on the non-transitory computer-readable medium. The one or more processors can be implemented as an integrated circuit (IC), an application specific integrated circuit (ASIC), or a large-scale integrated circuit (LSI), a system LSI, an ultra LSI, or an ultra LSI package that performs some or all of the functions described in this disclosure.

In the present disclosure, there is further provided a computer program product comprising computer instructions which, when executed by one or more processors, implement the steps of the airline ticket management method as described above. The present disclosure can comprise the use of software, applications, computer programs, or algorithms. The software, applications, computer programs, or algorithms can be stored on a non-transitory computer-readable medium to cause a computer, such as one or more processors, to perform the steps described above and in the accompanying drawings. For example, one or more memories store software or algorithms in executable instructions, and one or more processors can associate execution of a set of instructions of the software or algorithms to provide various functions according to the embodiments described in this disclosure.

The software and computer programs (which can also be referred to as programs, software applications, applications, components or code) comprise machine instructions for a programmable processor, and can be implemented in a high-level procedural language, object-oriented programming language, functional programming language, logical programming language, or assembly language or machine language. A term “computer-readable medium” refers to any computer program product, apparatus or device used for providing machine instructions or data to a programmable data processor, for example, a disk, an optical disc, a solid-state storage device, a memory, and a programmable logic device (PLD), which comprises a computer-readable medium that receives machine instructions as computer-readable signals.

By way of example, the computer-readable medium can comprise a dynamic random access memory (DRAM), random access memory (RAM), read-only memory (ROM), electrically erasable read-only memory (EEPROM), compact disc read-only memory (CD-ROM) or other optical disc storage device, disk storage device or other magnetic storage device, or any, other medium which can be used for carrying or storing required computer-readable program code in a form of instructions or data structures and which can be accessed by a general-purpose or special-purpose computer or a general-purpose or special-purpose processor. Disk or disc, as used herein, comprises a compact disc (CD), a laser disc, an optical disc, a digital versatile disc (DVD), a floppy disk and a Blu-ray disc, wherein the disk usually copies data magnetically and the disc copies data optically through a laser. Combinations of the above are also comprised within the scope of the computer-readable medium.

The subject matter of the present disclosure is provided as examples of the apparatus, system, method, and program for performing the features described in the present disclosure. However, in addition to the above features, other features or variations can be expected.

It can be expected that the implementations of the components and functions of the present disclosure can be accomplished with any emerging technology that may replace any of the above implemented technologies.

In addition, the above description provides examples without limiting the scope, applicability, or configuration set forth in the claims. Changes can be made to the functions and arrangements of elements discussed without departing from the spirit and scope of the present disclosure. In various embodiments, various processes or components can be appropriately omitted, replaced, or added. For example, features described with respect to certain embodiments can be combined in other embodiments.

In addition, in the description of the present disclosure, terms “first”, “second”, “third”, and the like are used for descriptive purposes only and cannot be construed as indicating or implying relative importance or order.

Similarly, while operations are depicted in the drawings in a specific order, this should not be understood as requiring that such operations be performed in the specific order shown or in a sequential order, or that all illustrated operations be performed, to achieve desirable results. In some cases, multitasking and parallel processing can be advantageous.

1. An airline ticket management method, comprising:
acquiring a distance addition instruction, wherein the distance addition instruction is configured to indicate a first distance and a first user, the first distance is an integer multiple of a minimum added distance; and
adding the first distance into a first distance pool of the first user.

2-6. (canceled)

7. The airline ticket management method according to claim 1, further comprising:
acquiring a distance redemption instruction, wherein the distance redemption instruction is configured to indicate a first travel starting point, a first travel ending point and a first travel time;
determining, according to a preset redemption rule, whether a redeemable airline ticket conforming to the first travel starting point, the first travel ending point and the first travel time exists; when the airline ticket exists, determining a second distance corresponding to the airline ticket; and
subtracting the second distance from the first distance pool and generating the airline ticket.

8-9. (canceled)

10. The airline ticket management method according to claim 7, wherein the determining, according to a preset redemption rule, whether the redeemable airline ticket conforming to the first travel starting point, the first travel ending point, and the first travel time exists comprises:
determining whether the first travel time falls within a flight time range of an airline ticket for which at least part of a distance in the first distance pool is redeemable;
if the first travel time falls within the flight time range, determining whether the airline ticket conforming to the first travel starting point, the first travel ending point and the first travel time exists; and
if the first travel time does not falls within the flight time range, generating first redemption failure information.

11. The airline ticket management method according to claim 7, wherein the determining, according to a preset redemption rule, whether the redeemable airline ticket conforming to the first travel starting point, the first travel ending point, and the first travel time exists comprises:
determining whether a current redemption time is within a validity period of at least part of a distance in the first distance pool;
if the current redemption time is within the validity period, determining whether the airline ticket conforming to the first travel starting point, the first travel ending point and the first travel time exists; and
if the current redemption time is not within the validity period, generating second redemption failure information.

12. The airline ticket management method according to claim 11, further comprising:
subtracting the first distance from the first distance pool and refunding a fare corresponding to the first distance, when the first distance has not been redeemed within a fifth time range after being added into the first distance pool,
wherein the fifth time range is determined at least according to a first validity period of the first distance.

13. The airline ticket management method according to claim 11, wherein the subtracting the second distance from the first distance pool comprises:
preferentially subtracting a distance with a validity period expired earlier from the first distance pool.

14. The airline ticket management method according to claim 11, further comprising:
determining whether an expiration time of a validity period of an existing distance in the first distance pool is earlier than a first expiration time of a first validity period of the first distance, after the first distance is added into the first distance pool of the first user; and
if the expiration time of the validity period of the existing distance is earlier than the first expiration time, determining whether the first expiration time is later than a preset longest expiration time;
if the first expiration time is later than the preset longest expiration time, prolonging the expiration time of the validity period of the existing distance to the preset longest expiration time; and
if the first expiration time is not later than the preset longest expiration time, prolonging the expiration time of the validity period of the existing distance to be consistent with the first expiration time.

15. The airline ticket management method according to claim 7, wherein the determining the second distance corresponding to the airline ticket comprises:
determining a first travel distance between the first travel starting point and the first travel ending point as the second distance.

16. The airline ticket management method according to claim 7, wherein the distance redemption instruction is further configured to indicate cabin information; and
the determining the second distance corresponding to the airline ticket comprises:
determining a first travel distance between the first travel starting point and the first travel ending point;
determining a cabin coefficient according to the cabin information; and
determining a product of the first travel distance and the cabin coefficient as the second distance.

17. The airline ticket management method according to claim 7, wherein the distance redemption instruction is further configured to indicate other fee information; and
the determining the second distance corresponding to the airline ticket comprises:
determining a first travel distance between the first travel starting point and the first travel ending point;
determining an eighth distance corresponding to the other fee information; and
determining a sum of the first travel distance and the eighth distance as the second distance.

18. The airline ticket management method according to claim 7, wherein the determining the second distance corresponding to the airline ticket comprises:
determining a third distance according to the distance redemption instruction;
determining whether the third distance is greater than a remaining distance in the first distance pool;
if the third distance is greater than the remaining distance in the first distance pool, taking the remaining distance as the second distance, and generating price difference information according to a difference between the third distance and the remaining distance; and
if the third distance is not greater than the remaining distance in the first distance pool, taking the third distance as the second distance.

19. The airline ticket management method according to claim 18, wherein the subtracting the second distance from the first distance pool and generating the airline ticket comprise:
determining whether a fare corresponding to the price difference information is acquired;
if the fare corresponding to the price difference information is acquired, subtracting the second distance from the first distance pool, and generating the airline ticket; and
if the fare corresponding to the price difference information is not acquired, generating third redemption failure information.

20. The airline ticket management method according to claim 2, further comprising:
acquiring a voluntary refund instruction, wherein the voluntary refund instruction is configured to indicate the airline ticket;
determining a fourth distance to be deducted according to a preset refund rule;
determining a difference between the second distance and the fourth distance as a fifth distance; and
returning the fifth distance into the first distance pool.

21-23. (canceled)

24. The airline ticket management method according to claim 7, further comprising:
acquiring a compulsory refund instruction, wherein the compulsory refund instruction is configured to indicate the airline ticket; and returning the second distance into the first distance pool.

25. The airline ticket management method according to claim 24, further comprising:
determining a sixth distance to be compensated according to the compulsory refund instruction; and
adding the sixth distance into the first distance pool.

26. (canceled)

27. The airline ticket management method according to claim 7, further comprising:
acquiring a voluntary rescheduling instruction, wherein the voluntary rescheduling instruction is configured to indicate the airline ticket and a target rescheduling time;
determining whether the voluntary rescheduling instruction conforms to a preset rescheduling rule;
if the voluntary rescheduling instructions conform to the present rescheduling rule, determining a ninth distance according to the preset rescheduling rule, and subtracting the ninth distance from the first distance pool; and
if the voluntary rescheduling instructions do not conform to a preset rescheduling rule, generating rescheduling failure information.

28. The airline ticket management method according to claim 1, further comprising:
when there is a seventh distance that has still not been redeemed into a distance pool of any user within a seventh preset time range after being purchased, returning a fare corresponding to the seventh distance.

29. An airline ticket management apparatus, comprising:
a memory having stored instructions thereon; and
a processor configured to execute instructions stored on the memory, to perform the airline ticket management method according to claim 1.

30. A computer-readable storage medium, comprising computer-executable instructions which, when executed by one or more processors, cause the one or more processors to perform the airline ticket management method according to claim 1.

31. A computer program product, comprising computer instructions which, when executed by one or more processors, implement the steps of the airline ticket management method according to claim 1.
